(19) United States
(12) Patent Application Publication
(10) Pub. No.: US 2011/0042631 A1
(43) Pub. Date: Feb. 24, 2011

(54) CABLE-INSERTING APPARATUS

(75) Inventor: Hiroshi Tahara, Gifu-shi (JP)

Correspondence Address: BUCHANAN, INGERSOLL & ROONEY PC, POST OFFICE BOX 1404, ALEXANDRIA, VA, 22313-1404, US

(73) Assignee: Ichimatsu Denki Koji Co., Ltd., Gifu-shi (JP)

(21) Appl. No.: 12/546,308

(22) Filed: Aug. 24, 2009

(51) Int. Cl. H02G 1/08

(52) U.S. Cl. 254/134.4

(57) ABSTRACT

The closed long bag enclosed a little air is connected to the preliminary line for inserting cable into the conduit by the small suction pump. The shape of closed long bag enclosed a little air can be changed easily. As the result, the closed long bag moves through a narrow portion and a bending portion of the conduit smoothly. Furthermore, air in a tail portion of the closed long bag moves to a head portion of the closed long bag by difference between the front portion and the end portion of the closed long bag. The head portion of the bag expands and the tail portion of the bag shrinks. As the result, the bag pulls the line very strongly.

### BACKGROUND OF THE INVENTION

1. Field of the Invention

This present invention relates to a cable-inserting apparatus used for the cable-inserting work of a cable through a conduit.

2. Description of the Related Art

A preliminary line is employed for the cable traction in the conduit. It is known to use a suction apparatus to cause an air flow in the conduit for inserting the preliminary line through the conduit. The air flow gives a driving force to a thrust member connected to a top portion of the preliminary line. The suction apparatus absorbs the air from an end portion (outlet portion) of the conduit through an air hose.

For example, U.S. Pat. No. 6,746,000 owned by the applicant adopts a tape-shaped preliminary line. The fluid resistance of the tape-shaped preliminary line generates the driving force. However, the driving force of the tape-shaped preliminary line is not strong.

A known parachute-shaped thrust member generates the thrust by the differential pressure between a front portion and a back portion of the thrust member. The differential pressure generates a stronger thrust than the tape-shaped preliminary line if the conduit is straight and clean. However, the air flow often flows in a gap between an inner surface of the conduit and the parachute if the parachute closes at a bending portion of the conduit or at obstacles on the inner surface of the conduit. The strings of the parachute are easily caught on a projection of the inner surface of the conduit. The strings twisted by the rotation of the parachute narrows an end opening of the parachute. The parachute-shaped thrust member does not yet reach the practical use level.

There are various kinds of obstacles such as rust, water and the cable in the conduit.

It is necessary for the thrust member to generate the strong driving force to pull the preliminary line in the long conduit with the obstacles. The thrust member must have the strong pulling strength to endure the thrust. The thrust member must have the strength that is not damaged by friction with the obstacle in the conduit.

The shape of the thrust member must flexibly transform if a cross sectional shape of the conduit transforms. However, there is often water in the conduit. The parachute often fades away by the water in the conduit. Furthermore, if suction apparatus absorbs the water or the sand, the suction power is deteriorated easily.

A flexible air hose is adopted to lead the air flow in the conduit to the inlet portion of the suction apparatus. On the real cable-inserting work, the cable is inserted in the conduits with various sizes. The top portion of the air hose can have a bowl-shaped cup for connection with the conduit.

The bowl-shaped cup adhered to a side wall surface around the outlet portion of the conduit permits change of size of the conduit. However, the bowl-shaped cup can not adhere to a side wall surface around the outlet portion of the conduit when there is already a cable in the conduit. The large-scale suction apparatus such as the sewage vacuum truck is employed for the long conduit with many bending portions.

However, the large-scale suction apparatus such as the sewage vacuum truck can not be employed at special work environment such as an upper floor of the building. The small suction apparatus with the small suction power can not be employed for pulling a long preliminary line.

### SUMMARY OF THE INVENTION

It is the 1st object of the present invention to provide a new cable-inserting apparatus with strong thrust and superior transportability. It is the 2nd object of the present invention to provide a new cable-inserting apparatus that is suitable for a diameter change of the conduit. It is the 3rd object of the present invention to provide a new cable-inserting apparatus with the easy operation.

(The Fundamental Feature of the Present Invention)

The cable-inserting apparatus of the present invention to insert a cable into a conduit has a preliminary line, a thrust member, a suction apparatus and an air hose. The thrust member connected to a top portion of the preliminary line generates the driving force by the air flow in the conduit. The thrust member pulls the preliminary line. The suction apparatus absorbs the air flow in the conduit from an outlet portion of the conduit. The air hose communicates the outlet portion of the conduit to the suction apparatus.

(The First Feature of the Present Invention)

As for the first feature of the present invention, the thrust member consisting of a closed long bag made from soft and thin material encloses air or gas partially and adheres around the inner surface of the conduit. The thrust member can consist of the plural closed long bag. The closed long bag under the atmospheric pressure accommodates a volume of air being equal to a volume of 5-60% of the biggest capacity of the closed long bag. When the closed long bag under the atmospheric pressure accommodates a volume of air being less than 5% of the biggest capacity of the closed long bag, the leaked air flow between the inner surface of the conduit and the outer surface of the closed long bag increases. When the closed long bag under the atmospheric pressure accommodates a volume of air being more than 60% of the biggest capacity of the closed long bag, it is difficult to pass the narrow portion or the bending portion of the conduit for the closed long bag.

When the air flow in the conduit is absorbed by the suction apparatus, the air in the tail portion of the closed long bag moves to the head portion of the closed long bag because the pressure of the head portion decreases by the suction pressure. The pressure of the tail portion of the closed long bag is almost equal to the atmospheric pressure. The diameter of the head portions of the closed long bag increases. The shrunken tail portion of the closed long bag becomes mostly the string-shape. As the result, the closed long bag has mostly ladle-shape. The air enclosed in the closed long bag moves beyond the obstacle in the conduit backward and forward. As the result, the shape of the closed long bag smoothly transforms in accordance with the shape of the bending portion of the conduit or the obstacle.

Accordingly, the closed long bag partially enclosed air generates the strong driving force. The ladle-shaped closed long bag can move ahead in the conduit with various sizes. Furthermore, the ladle-shaped closed long bag generates the strong thrust in the conduit. Because only the head portion of the closed long bag adheres to the inner surface of the conduit. The tail portion of the closed long bag does not adhere to the inner surface of the conduit.

The closed long bag generates the strong thrust because the top portion of the closed long bag prevents leakage of the air flow between the bag and conduit. The closed long bag has small frictional resistance because the tail portion of the bag does not contact the inner surface of the conduit. As a result, the small suction apparatus can pull the closed long bag connected to the preliminary line.

Accordingly, the closed long bag partially accommodating air generates the stronger thrust in comparison with the parachute-shaped thrust member. The top portion of the preliminary line is connected to the end portion of the closed long bag. It is desirable for the closed long bag to be formed with a soft resin film.

For example, the closed long bag is formed of a resin film of which thickness is 1-100 μm. For example, the closed long bag has the rectangular flat shape in condition of that air is not enclosed inside. For example, the length of the closed long bag is 2-20 times of the width of the closed long bag in the condition of flatness. Preferably, the length of the closed long bag is 4-10 times of the width of the closed long bag in the condition of flatness. For example, the closed long bag has a hemispheric leader. For example, the closed long bag has long envelope shape.

In preferred embodiment, the closed long bag has a resin bag portion and a reinforcement portion joined on an outer surface of the resin bag portion. The resin bag portion is made from the resin film which can enclose air inside. The reinforcement portion has stronger pulling strength than the resin bag portion. For example, the closed long bag has the resin film as the resin bag portion and the fiber layer as the reinforcement portion. The fiber layer can consist of a cloth or a net.

The reinforcement portion reduces the frictional resistance of the closed long bag and the abrasion. The reinforcement portion extends from the top portion of the resin bag portion to the preliminary line. The end portion of the reinforcement portion reaches the top portion of the preliminary line. Tension of the resin bag portion is reduced.

The reinforcement portion can have a basket-shape or a net-shape. The reinforcement portion covers the resin bag portion. The reinforcement portion prevents damage of the resin bag portion. Furthermore, the reinforcement portion reduces frictional resistance.

The reinforcement portion consists of threads or tapes joined on an outer surface of the resin bag portion. The reinforcement portion extends to the axial direction of the resin bag portion.

As for the preferred embodiment, the closed long bag has a screw cap closing an opening for injection of air.

(The Second Feature of the Present Invention)

As for the second feature of the present invention, the top portion of the air hose is inserted in a cone-shaped pipe having the openings at the both ends. The top portion of the cone-shaped pipe having a smaller diameter than the conduit is inserted and fixed to the top portion (the inlet portion) of the air hose or the joint pipe jointed to the top portion of the air hose. The end portion of the cone-shaped pipe has the larger diameter than the conduit.

The cone-shaped pipe prevents leakage of air from the opening of the end portion of the conduit even if the inner diameter of the conduit changes. The cone-shaped pipe of which the top portion is inserted into the conduit can be fixed to the conduit and holds the top portion of the air hose well. As for the preferred embodiment, the rubber layer is formed on the outer peripheral surface of the cone-shaped pipe. As a result, the rubber layer prevents the leakage of the air even if the end portion (the outlet portion) of the conduit has the projections.

(The Third Feature of the Present Invention)

As for the third feature of the present invention, the air hose has a water tank for separating the water from the air flow. The water tank is placed at the intermediate portion of the air hose. The water tank separates the water from the air flow sent to the suction apparatus. The air hose has the first hose portion and the second hose portion. The first air hose portion is connected to an opening of the outlet portion of the conduit.

The second hose portion is connected to an intake of the suction apparatus. The end portion of the first hose portion and the top portion of the second hose portion vertically extends in a water tank. The water tank separates the water drops from the air flow by changing the direction of the air flow in the water tank. Accordingly, trouble of the expensive suction apparatus can be prevented. Furthermore, the water tank separates sand from the air flow.

As for the preferred embodiment, the water tank has a water pump. The water pump discharges the water in the water tank outside. Preferably, the water pump is fixed to the water tank. Preferably, the water pump has a check valve for preventing the leakage of air through the water pump when the water pump stops.

(The Fourth Feature of the Present Invention)

As for the fourth feature of the present invention, the air hose consists of plural small air hoses having the end portions connecting to plural suction apparatuses individually.

The top portions of the small air hoses absorb the air flow in parallel from the end portion of the conduit.

Namely, the end portion of the air hose consists of the plural small hoses connecting to the plural small suction apparatuses individually. Each small suction apparatus absorbs air in the conduit. As a result, the thrust member pulls the preliminary line strongly without employing the large and heavy suction apparatus. When the friction resistance of the preliminary line is not much, a part of the small air hose is plugged.

As for the preferred embodiment, each top portion (inlet portion) of the small air hoses is inserted in the cone-shaped pipe. The diameter of the top portion of the cone-shaped pipe is smaller than the conduit. The diameter of the end portion of the cone-shaped pipe is larger than the conduit. The inlet portions of the small air hoses can be jointed to the connecting pipes fixed to the cone-shaped pipe. The inlet portions of the small air hoses can be fixed each other. The cone-shaped pipe can be fixed to the inlet portion of each small air hose.

As for the preferred embodiment, the rubber layer is formed on an outer peripheral surface of the cone-shaped pipe to prevent the leakage of air. As for the preferred embodiment, the cone-shaped pipe has a net-shaped member to prevent an invasion of the preliminary line into the small air hoses. The net-shaped member is arranged forward than the small air hoses. The net-shaped member can be fixed to the top portion (inlet portion) of the small air hoses.

(The Fifth Feature of the Cable-Inserting Apparatus of the Present Invention)

As for the fifth feature of the present invention, the cable-inserting apparatus has a joint hose. The joint hose has an elastic cylinder member and a pipe member.

The elastic cylinder having an air chamber and a through-hole is inserted in the outlet portion of the conduit. The air chamber in which a fluid is enclosed has a bigger outer diameter than the inner diameter of the conduit in the state that air is injected. The through-hole being independent from the air chamber is inserted by the pipe member.

The pipe member inserting through the through-hole moves air flow in the conduit to the air hose. Air or water or oil or grease or gel is enclosed in the air chamber. The elastic cylinder member can consist of an air bag. This elastic cylinder member is inserted in the outlet portion of the conduit. The air bag as the elastic cylinder member inflates by means of injection of air. The elastic cylinder member consists of a rubber sheet or a resin sheet.

An elastic cylinder member has the through-hole which the pipe member is inserted through. An outer peripheral surface of the elastic cylinder member adheres to the inner peripheral surface of the conduit. An inner peripheral surface of the elastic cylinder member facing the through-hole adheres to the outer peripheral surface of the pipe member. As a result, leakage of air is prevented.

The elastic cylinder member prevents the leakage of air through the gap between the conduit and the elastic cylinder member. Furthermore, the elastic cylinder member prevents the leakage of air through the gap around a cable which already exists through the conduit because the elastic cylinder member has the excellent flexibility.

As for the preferred embodiment, the pipe member penetrates the through-hole of the elastic cylinder member.

As for the preferred embodiment, a net disposed at the top portion of the pipe member prevents to insertion of the preliminary line to the pipe member. As for the preferred embodiment, the pipe member is joined to the elastic cylinder member. As for the preferred embodiment, the end portion of the pipe member can joint to the air hose with use of well-known screw structure or well-known fit structure. As for the preferred embodiment, the pipe member combines the top portion of the air hose. As for the preferred embodiment, the elastic cylinder member is made from rubber. As for the preferred embodiment, the end portion of the elastic cylinder member is larger than the top portion of the elastic cylinder member.

As for the preferred embodiment, the pipe member has a stopper portion adhering to the end surface of the elastic cylinder member. As for the preferred embodiment, the elastic cylinder member has plural through-holes inserted the plural pipe member separately. The plural air hoses connect plural pipe members to the plural small suction apparatuses separately.

### BRIEF DESCRIPTION OF THE DRAWING

FIG. 1 is a vertical section view of the cable-inserting apparatuses of embodiment 1.

FIG. 2 is a side view of the closed long bag shown in FIG. 1.

FIG. 3 is a side view showing an arranged closed long bag.

FIG. 4A and FIG. 4B are side views showing an arranged closed long bag passing an obstacle.

FIG. 5A, 5B, 5C and 5D are side views showing an arranged closed long bag.

FIG. 6 is a side view of the closed long bag of embodiment 2.

FIG. 7 is an enlarged partial side view of the closed long bag shown in FIG. 6.

FIG. 8 is a side view of a closed long bag of embodiment 3.

FIG. 9 is an enlarged partial side view showing an arranged closed long bag shown in FIG. 8.

FIG. 10 is enlarged axial sectional view of the top portion of the air hose of embodiment 4.

FIG. 11 is a vertical section view showing a water tank of embodiment 5.

FIG. 12 is a vertical section view of the cable-inserting apparatus of embodiment 6.

FIG. 13 is a vertical section view of the air hose of embodiment 7.

FIG. 14 is an enlarged radial sectional view of an air hose shown in FIG. 13.

FIG. 15 is a vertical section view showing a water tank of embodiment 8.

FIG. 16 is a vertical section view of the air hose of embodiment 9.

FIG. 17 is a vertical section view of the air hose of embodiment 10.

FIG. 18 is a vertical section view of the air hose of embodiment 11.

### DETAILED DESCRIPTION OF THE PREFERRED EMBODIMENTS

### Embodiment 1

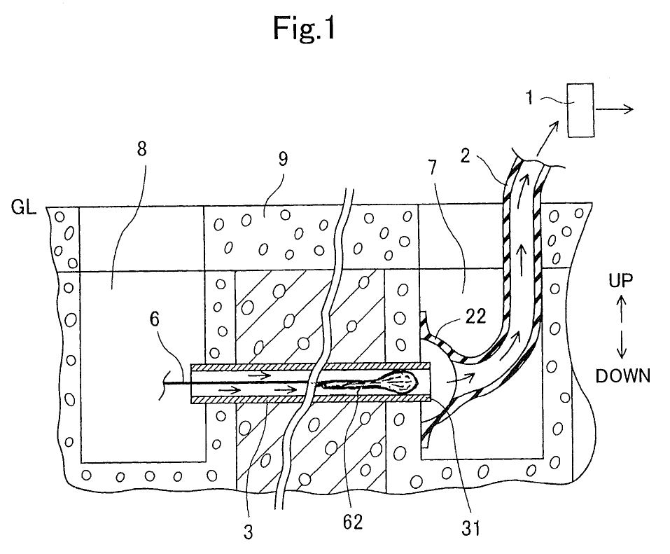

Embodiment 1 is explained referring to FIG. 1. FIG. 1 is schematic sectional view of the cable-inserting apparatus. The suction apparatus 1 is driven by a motor.

The air hose 2 made from rubber or resin connects the outlet portion (end portion) of the conduit 3 to the suction apparatus 1. The suction apparatus 1 absorbs air in the conduit 3 through the air hose 2. The conduit 3 is buried under a road.

The preliminary line 6 consisting of plural steel twist lines is inserted in the conduit 3. The both end of the conduit 3 projects from the side walls of a manhole 7 and a manhole 8 respectively. A pavement portion 9 covers the surface of the road. For example, the distance between the manhole 7 and 8 is around 300-500 meters along the road. The end portion (the outlet portion) 31 of conduit 3 opens in the side wall of the manhole 7. The tail portion of a closed long bag 62 as the thrust member is fixed to the top portion of the preliminary line 6.

A bowl-shaped cylinder member 22 consists of a top portion (an inlet portion) of the air hose 2. A bowl-shaped cylinder member 22 made from rubber adheres to the side wall surface of the manhole 7 and covers the outlet portion 31 of the conduit 3. The air in the conduit 3 is absorbed through the air hose 2 by driving the suction apparatus 1. By difference of pressures between the head portion and the tail portion of the closed long bag 62, the preliminary line 6 moves toward the outlet portion 31 of the conduit 3.

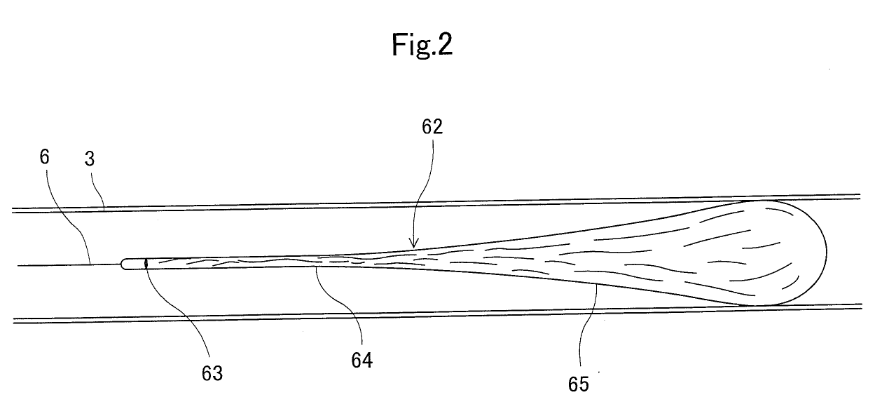

The closed long bag 62 is explained referring to FIG. 2. The closed long bag 62 consists of a long bag formed in a shape of a long envelope. The tail portion 64 of the closed long bag 62 is connected to the top portion of the preliminary line 6 to insert a cable through the conduit 3. For example, the closed long bag 62 is formed in the shape of a long pipe by a polyethylene film or a polyethylene sheet.

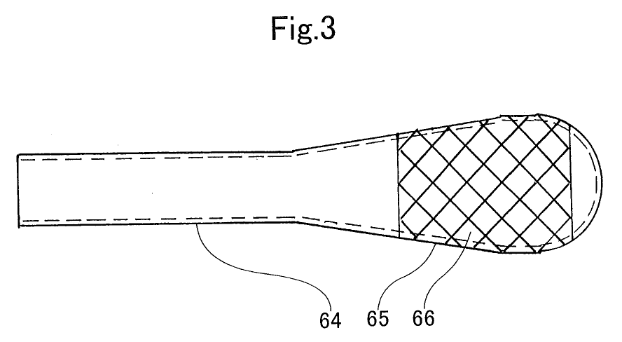

A little air is enclosed in closed long bag 62. The opening for air injection made at the tail portion 64 of the closed long bag 62 is closed. The tail portion 64 of the closed long bag 62 is connected to the top portion of preliminary line 6. FIG. 3 shows a resin net 66 bonded to the head portion 65 of the closed long bag 62. The resin net 66 decreases friction and damage of the head portion 65. Tail portion 64 is closed after injecting of air.

The quantity of the air in the closed long bag 62 is equal to 5-70% of the biggest capacity of the closed long bag 62 under the atmospheric pressure. Furthermore, the quantity of the air in the closed long bag 62 is equal to 10-60% or 20-50% of the biggest capacity of the closed long bag 62 under the atmospheric pressure. The length of the closed long bag 62 is 4-10 times of the width of the closed long bag 62. The resin film constituting the closed long bag 62 has the thickness of 10-100 μm.

The cable-inserting process with the closed long bag 62 is explained. A long bag, the preliminary line 6, the suction apparatus 1 and the air hose 2 are prepared. Next, the appropriate amount of air is injected in the long bag. The closed long bag 62 is made by closing the opening of long bag. The closed long bag 62 is fixed to a top portion of the preliminary line 3. The closed long bag 62 is set at the inlet portion of the conduit 3 in the manhole 8. The top portion of the air hose 2 lengthening from the suction apparatus 1 is set around the outlet portion 31of the conduit 3 in the manhole 7.

The suction apparatus 1 is started. The head portion of the closed long bag 62 is inserted in the inlet portion 31 of the conduit 3. The closed long bag 62 is moved toward the outlet portion of the conduit 3 by air flow generated by the suction apparatus 1. The head portion of the closed long bag 62 is enlarged in the conduit 3. The head portion of the closed long bag 62 can seal the conduit. The closed long bag 62 hereby pulls the preliminary line 6 strongly.

The closed long bag 62 is removed from the top portion of the preliminary line 6 after the preliminary line 6 reaches out the outlet portion 31 of the conduit 3. A cable is connected to the top portion of the preliminary line 6. The cable is inserted through the conduit 3 by pulling the preliminary line 6 toward the opposite direction.

The above described cable-inserting process is operated at high speed by the strong driving force generated by the closed long bag 62. Namely, the enlarged head portion and shrieked tail portion of the closed long bag 62 can seal the conduit 3 with small friction. The closed long bag 62 pulls the preliminary line 6 strongly. Furthermore, the shape of the closed long bag 62 flexibly follows a curve of the conduit 3.

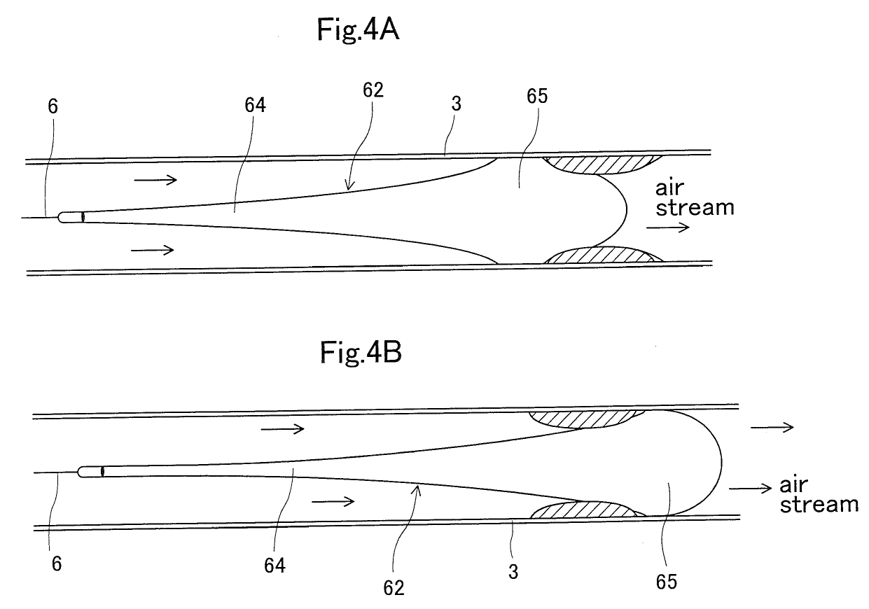

For example, the head portion of the closed long bag 62 can pass through the obstacle on the inner surface of the conduit because the air in the top portion of the bag 62 easily moves backward to the tail portion as shown in FIG. 4A and FIG. 4B. After passing through the obstacle, the air in the tail portion of the bag 62 moves forward to the head portion of the closed long bag 62.

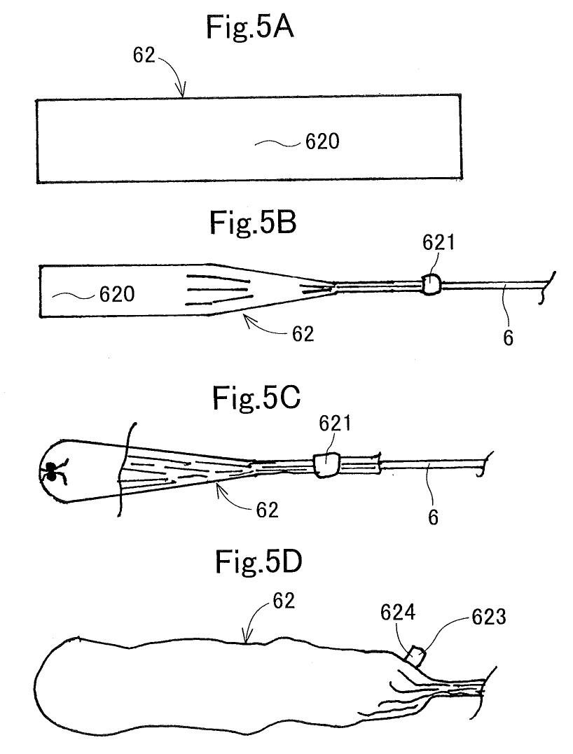

FIG. 5 shows the arranged shape of the closed long bag 62. FIG. 5A shows opened resin bag 620 like a long envelope having the rectangular shape. The right-side end of the resin bag 620 is opened. The opening is closed after injection of the appropriate air into the resin bag 620. FIG. 5B shows the state after the internal air moved forward to the head portion of the bag. FIG. 5C shows the other arrangement of the closed long bag 62. The rectangular long bag having of which both ends are opened is prepared. The long bag is reversed after the front edge of the long bag was tied up.

FIG. 5D shows the other arrangement of the closed long bag 62. The small pipe member 623 for injection of air is fixed to the end portion of the closed long bag 62.

The small pipe member 623 is closed by the cap 624.

### Embodiment 2

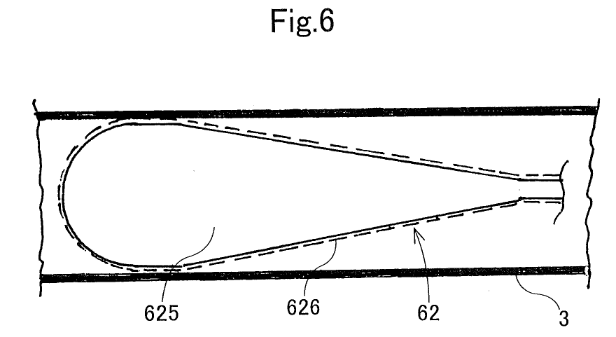

Embodiment 2 is explained referring to FIG. 6. FIG. 6 is a side view of the closed long bag 62. The closed long bag 62 catches the differential pressure in the conduit 3.

The closed long bag 62 has the resin bag portion 625, and the reinforcement portion 626. The resin bag portion 625 which can enclose air inside is made from the resin film.

The pulling strength of the reinforcement portion 626 is superior. The reinforcement portion 626 made with a resin net covers the resin bag portion 625.

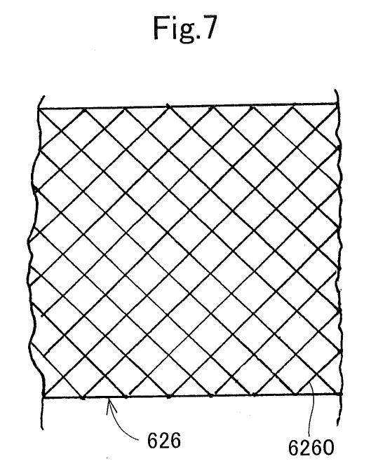

FIG. 7 is the enlarged partial side view of the reinforcement portion. The end portions of the reinforcement portion 626 and the resin bag portion 625 are connected to the top portion of the preliminary line 6.

### The Embodiment 3

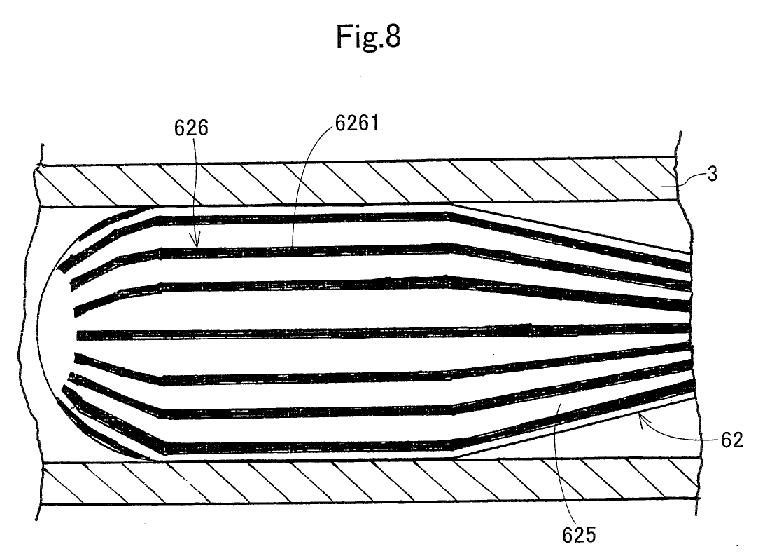

The embodiment 3 is explained referring to FIG. 8. FIG. 8 is a schematic radial sectional view of the closed long bag 62. The closed long bag 62 has the resin bag portion 625 and the reinforcement portion 626 joined each other. The resin bag portion 625 is a sealed bag consisting of the resin film. The reinforcement portion 626 is made from resin tapes 6261 having superior strength.

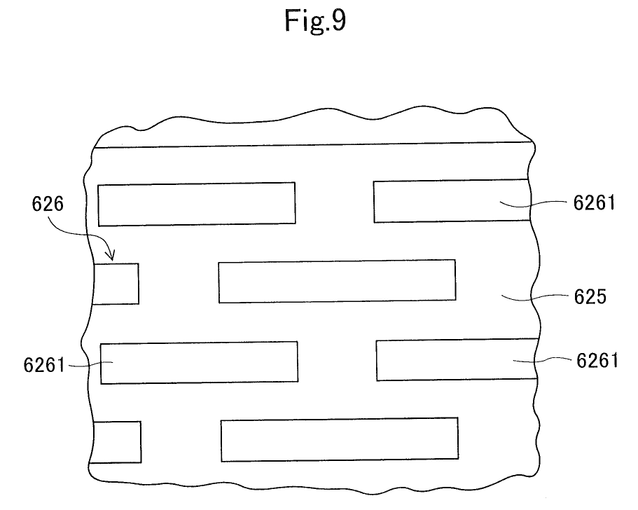

FIG. 9 shows an arrangement of the closed long bag shown in FIG. 8. Short resin tapes 6261 are bonded on the surface of the resin bag portion 625.

### The Embodiment 4

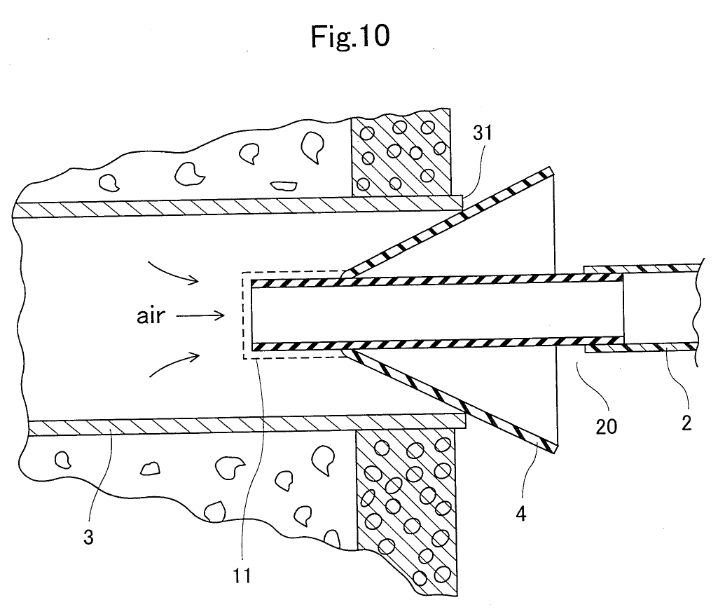

The embodiment 4 is explained referring to FIG. 10. FIG. 10 is a vertical sectional view enlarges the top portion of the air hose 2. The cone-shaped pipe 4 is inserted to the end portion (outlet portion) 31 of the conduit 3. The joint pipe 20 is inserted through the top opening of the cone-shaped pipe 4 and fixed to the cone-shaped pipe 4. The air hose 2 connects the joint pipe to the suction apparatus.

The cone-shaped pipe 4 is a rubber member with the shape of the conic barrel. The diameter of the top portion of the cone-shaped pipe 4 is smaller than the inner diameter of the conduit 3. The diameter of the end portion of the cone-shaped pipe 4 is larger than the inner diameter of the conduit 3.

The top portion of the cone-shaped pipe 4 fixed to the joint pipe 20 is inserted into the outlet portion 31 of conduit 3. The outer peripheral surface of the cone-shaped pipe 4 adheres to the outlet portion 31 of the conduit 3. The cone-shaped pipe 4 prevents the invasion of air from the opening of the outlet portion 31 of conduit 3.

### The Embodiment 5

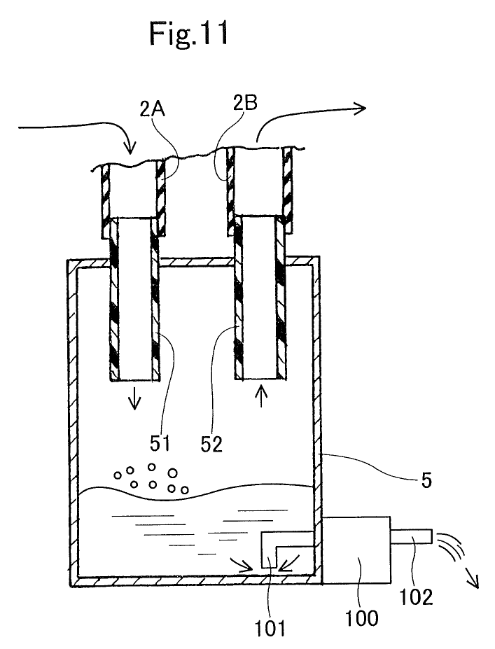

The embodiment 5 is explained referring to FIG. 11. FIG. 11 shows the water tank 5 arranged on an intermediate portion of the air hose 2. The pipe member 51 and the pipe member 52 are glued at the openings of the water tank 5.

The air hose 2 has the first hose 2A and the second hose 2B. The first hose 2A makes communication between the conduit 3 and the pipe member 51. The second hose 2B makes communication between the pipe member 52 and the suction apparatus 1. In FIG. 3, the illustration of the conduit 3 and the suction apparatus 1 are abbreviated.

The end portion of the first hose 2A is connected to the pipe member 51. The top portion of the second hose 2B is connected to the pipe member 52. When the suction apparatus 1 is driven, the air in the conduit 3 is drained outside through the first hose 2A, the water tank 5, the second hose 2B and the suction apparatus 1.

If the air flow accompanies water or sand, they move to the water tank 5 with the air flow. The pipe member 51 and the pipe member 52 have an opening at low position in the water tank 5. Therefore, drops of water and the sand are accumulated in the bottom of the water tank 5.

Accordingly, the suction apparatus 1 absorbs the clean air flow without the water and the sand. As a result, the durability of the suction apparatus 1 is improved. A water pump 100 is fixed on the side of the water tank 5.

The water pump 100 discharge the water in the water tank 5 through an inner pipe member 101 and an outer pipe member 102. A water level sensor (not shown) is disposed in the water tank 5. When the water level in the water tank 5 is higher than a predetermined high level, the water level sensor drives the water pump 100. When the water level is lower than a predetermined low level, the water level sensor cuts off the water pump 100.

The pipe member 102 has a check valve (not shown). The check valve prevents the air leakage into the water tank 5 from the pipe member 102 after the water pump stops.

### The Embodiment 6

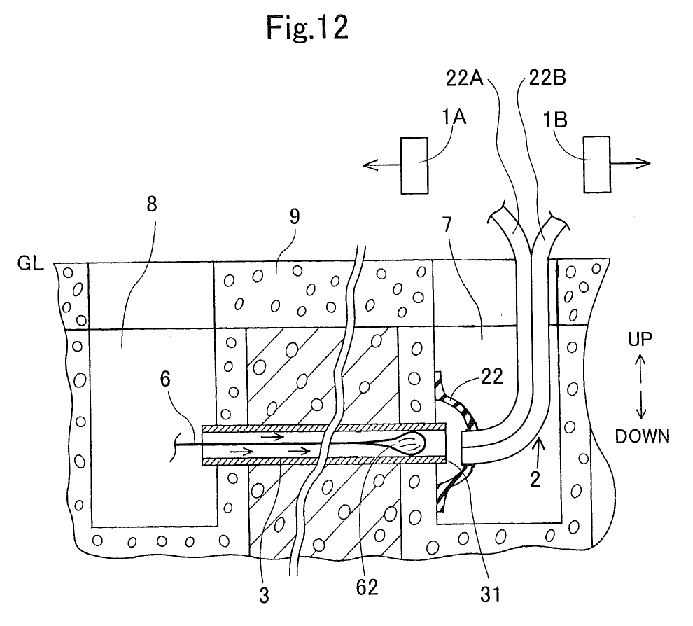

The embodiment 6 is explained referring to FIG. 12. FIG. 12 is a vertical section view showing the schematic constitution of the cable-inserting apparatus of the embodiment 6. The small suction apparatus 1A and 1B are adopted instead of the large suction apparatus explained above. The air hose 2 made from rubber or resin consists of two small air hoses 22A and 22B.

The outlet portion of the small air hose 22A is connected to an inlet portion of the small suction apparatus 1A. The outlet portion of small air hose 22B is connected to an inlet portion of the small suction apparatus 1B. The small suction apparatus 1A absorbs air through the small air hose 22A.

The small suction apparatus 1B absorbs air through the small air hose 22B. The tail portion of the thrust member 62 is fixed to the preliminary line 6. The top portion of the air hose 2 consisting of the small air hoses 22A and 22B is connected to the cylinder member 22.

The bowl-shaped cylinder member 22 and the air hose 2 are made from rubber. The top portions of small air hoses 22A and 22B project in the cylinder member 22. The small suction apparatuses 1A and 1B absorb air in the conduit 3 through the air hose 2. As air hose 2 consists of the small air hoses 22A and 22B in parallel, two small suction apparatuses 1A and 1B can make the strong air flow.

### The Embodiment 7

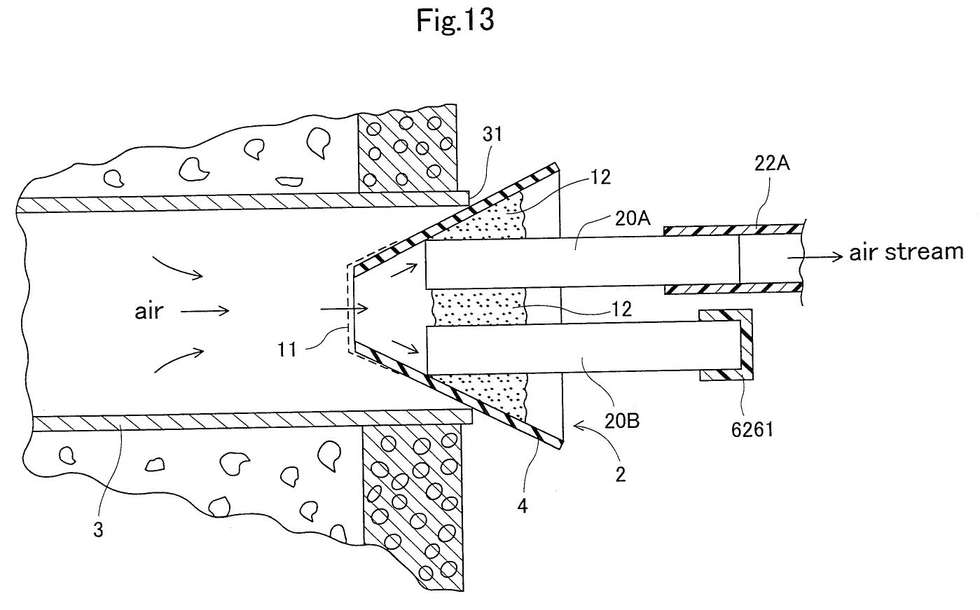

The embodiment 7 is explained referring to FIG. 13. FIG. 13 is an enlarged schematic sectional view of the top portion of the air hose 2. The cone-shaped pipe 4 is covered the top portions of the joint pipes 20A and 20B. The cone-shaped pipe 4 is fixed to the top portions of the joint pipes 20A and 20B.

The end portion of the joint pipe 20A is connected to the top portion of the small air hoses 22A. The end portion of the joint pipe 20B is closed by the cap 6261. The cone-shaped pipe 4 made from rubber has the form of a conic barrel. The cone-shaped pipe 4 can prevent the air invasion from the outlet portion 31 into the conduit 3. The top portions of the joint pipes 20A and 20B are disposed in the cone-shaped pipe 4.

A seal member 12 is filled up the gap between the cone-shaped pipe 4 and the joint pipes 20A and 20B. The seal member 12 joins the cone-shaped pipe 4 to the joint pipe 20A and 20B. The top portion of the cone-shaped pipe 4 has a smaller diameter than the conduit 3. The top portion of the cone-shaped pipe 4 is inserted in the outlet portion 31 of the conduit 3. The end portion of the cone-shaped pipe 4 has the larger diameter than the conduit 3.

As the cone-shaped pipe 4 has a conical surface, the outer peripheral surface of the cone-shaped pipe 4 can adhere to the outlet portion 31 of the conduit 3. A wire net 11 fixed in the top of the cone-shaped pipe 4 stops the thrust member 62.

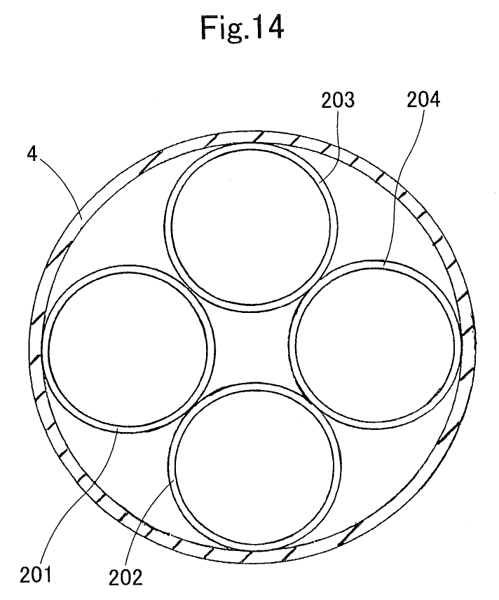

FIG. 14 shows the embodiment having the four joint pipe 20A, 20B, 20C and 20D inserted in the cone-shaped pipe 4. In this case, four small suction apparatuses can be employed.

### The Embodiment 8

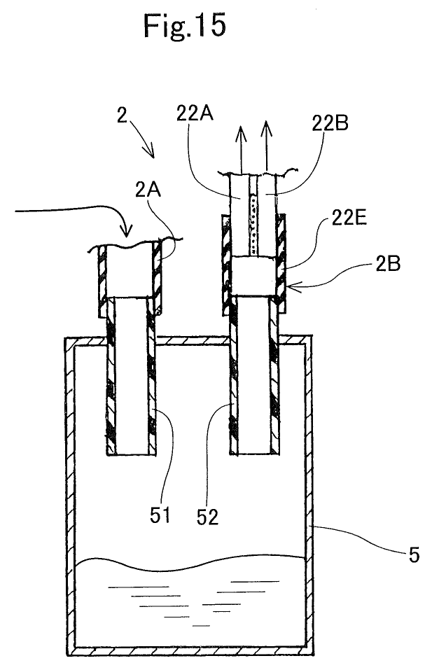

The embodiment 8 is explained referring to FIG. 15. FIG. 15 shows the water tank 5 arranged on an intermediate portion of the air hose 2. The pipe members 51 and 52 are glued together at the opening of the upper end of the water tank 5. The air hose 2 consists of the first hose 2A and the second hose 2B.

The first hose 2A connects the pipe member 51 to the conduit 3. The first hose 2A consists of one air hose. The second hose 2B connects the pipe member 52 to the suction apparatus. The second hose 2B consists of the pipe member 22E, the small air hose 22 and the small air hose 22B.

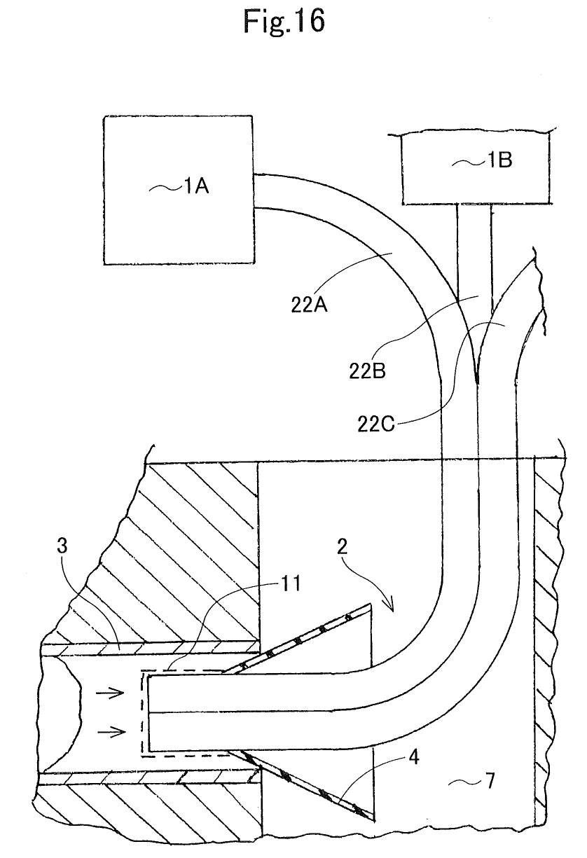

The pipe member 52 connects the second hose 2B to the small air hoses 22A and 22B. The end portion of the small air hose 22A is connected to the inlet portion of the small suction apparatus 1A (shown in FIG. 16). The end portion of the small air hose 22B is connected to the inlet portion of the small suction apparatus 1B (shown in FIG. 16).

Air in the water tank 5 is absorbed through the small air hoses 22A and 22B by the small suction apparatuses 1A and 1B. The small suction apparatuses 1A and 1B absorb the air in the conduit 3 through the first hose 2A, the water tank 5 and the second hose 2B. Water or sand included in the air flow is separated and accumulated in the water tank 5 because the pipe members 51 and 52 are fixed vertically in the water tank 5.

### The Embodiment 9

The embodiment 9 is explained referring to FIG. 16. FIG. 16 is a vertical section view showing around the air hose of the cable-inserting apparatus. The air hose 2 consists of three small air hoses 22A, 22B and 22C. The top portions of the small air hoses 22A, 22B and 22C project from the top portion of the cone-shaped pipe 4. The small air hoses 22A, 22B and 22C are connected to three small suction apparatuses separately.

Only two small suction apparatuses 1A and 1B are illustrated in FIG. 16. The top portions of the small air hoses 22A, 22B and 22C are fixed each other. The top portions of the small air hoses 22A, 22B and 22C are inserted in the cone-shaped pipe 4. The wire net 11 is covered the top portions of the small air hoses 22A, 22B and 22C. The wire net 11 stops the closed long bag as the trust member.

### The Embodiment 10

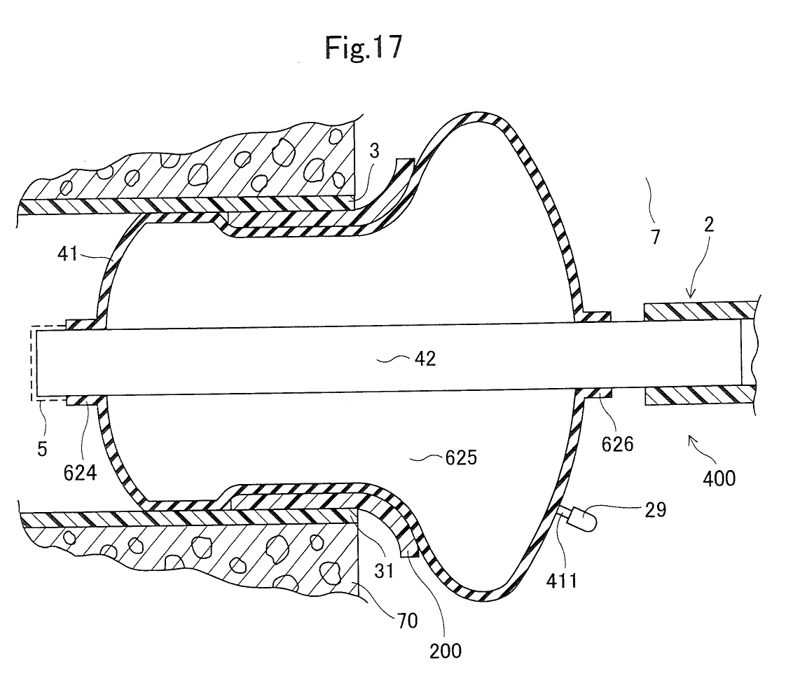

The embodiment 10 is explained referring to FIG. 17. FIG. 17 is an enlarged sectional view of an important part of the cable-inserting apparatus. The air hose 2 made from the rubber or the resin is connected to the suction apparatus 1. The inserting member 400 consists of an elastic cylinder member 41 and a joint pipe member 42. A bell mouse 200 is put on to the end portion (outlet portion) 31 of the conduit 3. A head portion of the elastic cylinder member 41 is inserted in the end portion 31 of the conduit 3.

A tail portion of the elastic cylinder member 41 having a larger diameter than the conduit 3 is disposed out of the conduit 3. A bell mouse 200 made from rubber is disposed between the end portion 31 of the conduit 3 and the elastic cylinder member 41. The elastic cylinder member 41 made from a rubber sheet or a resin sheet consists of a front pipe portion 624, a bag portion 625 and a back pipe portion 626.

The front pipe portion 624 is fixed to the front end of the bag portion 625. The back pipe portion 626 is fixed to the back end of the bag portion 625. A head portion of the bag portion 625 is inserted in the end portion 31 of the conduit 3. A tail portion of the bag portion 625 with larger diameter than the conduit 3 is disposed outside of the conduit 3.

The air injection pipe member 411 for injecting air in the bag portion 625 is fixed to the back end of the bag portion 625. The bag portion 625 has an air chamber in which air is filled through the air injection pipe member 411. A cap 29 shuts the air injection pipe member 411. The joint pipe member 42 of the inserting member 400 penetrates the front pipe portion 624, the bag portion 625 and the back pipe portion 626.

The joint pipe member 42 is adhered to the front pipe portion 624 and the back pipe portion 626. A top portion of the joint pipe member 42 projects forward from the front pipe portion 624. The compressed air in the sealed bag portion 625 prevents the leakage of air through a gap between the elastic bag portion 625 and the elastic bell mouse 200. Furthermore, the compressed air in the sealed bag portion 625 prevents the leakage of air through a gap between the elastic bell mouse 200 and the conduit 3. An end portion of the joint pipe member 42 is connected to the top portion of the air hose 2.

### Working Process

At first, the elastic cylinder member 41 is inserted in the end portion 31 of the conduit 3 except the tail portion of the bag portion 625. The air is injected in the bag portion 625 through the injection pipe member 411. By means of above simple work, the elastic cylinder member 41 is fixed to the end portion 31 of the conduit 3 without the air leakage. Finally, the air hose 2 is connected to the joint pipe member 42 and the suction apparatus is driven.

The important effect of the elastic cylinder member 41 is that the elastic cylinder member 41 can prevent the leakage of air between the elastic cylinder member 41 and the conduits with various sizes. Furthermore, the elastic cylinder member 41 can prevent the leakage of air between elastic cylinder member 41 and the cable already existing in the conduit. The bell mouse 200 can be abbreviated. The net 5 prevents the thrust member invades in the joint pipe member 42. Any elastic material is accommodated in the bag portion 625 instead of air.

### The Embodiment 11

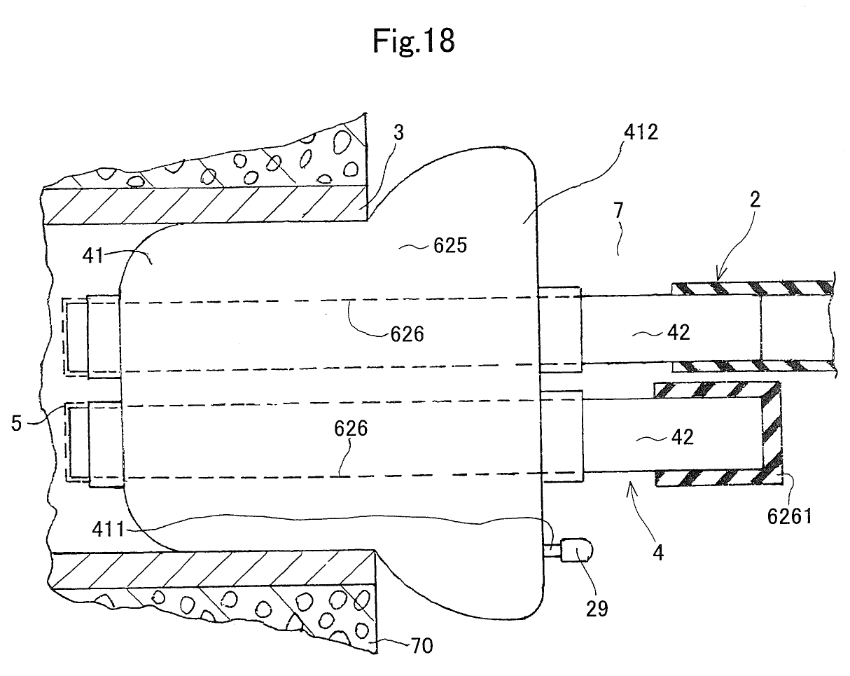

The embodiment 11 is explained referring to FIG. 18. FIG. 18 is an enlarged side view of an important portion of the cable-inserting apparatus. The apparatus in FIG. 18 employs plural joint pipe members 42 penetrating the bag portions 625 of the elastic cylinder member 41. However, FIG. 18 shows only two joint pipe members 42.

Each joint pipe members 42 is in parallel each other. One of the joint pipe members 42 is connected to the air hose 2. The cap closes the other one of the joint pipe members 42. Each of joint pipe members 42 can be connected to the each of small suction apparatus through each small air hose 2 individually. Therefore, the air in conduit 3 can be absorbed strongly by the plural suction apparatuses.

What is claimed is:

1. A cable-inserting apparatus comprising a thrust member 62 dragging a preliminary line 6 in a conduit 3 and an air hose 2 connecting a suction apparatus 1 to an end portion 31 of said conduit 3, wherein said thrust member 62 consists of a closed long bag 62 made from soft material encloses a predetermined volume of air or gas, wherein said predetermined volume is equal to the 5-70% of the greatest capacity of said closed long bag 62 in atmospheric pressure, wherein a length of said closed long bag 62 in a longitudinal direction is longer than a diameter of said closed long bag 62, and wherein said air or gas in a tail portion of said closed long bag 62 moves to a head portion of said closed long bag 62 in said conduit 3 in which air flow is making by said suction apparatus 1.

2. The cable-inserting apparatus according to claim 1, wherein said predetermined volume is equal to the 10-50% of the greatest capacity of said closed long bag 62 under atmospheric pressure.

3. The cable-inserting apparatus according to claim 1, wherein said closed long bag 62 has a resin bag portion 625 for enclosing air inside and a reinforcement portion 626 fixed to an outer surface of said resin bag portion 625 for reinforcing said resin bag portion 625.

4. The cable-inserting apparatus according to claim 2, wherein said reinforcement portion 626 consists of a net.

5. The cable-inserting apparatus according to claim 1, wherein said cone-shaped pipe 4 has a top portion with smaller diameter and a end portion with larger diameter than an inner diameter of said conduit 3, wherein said top portion of said cone-shaped pipe 4 is inserted in an end portion 31 of said conduit 3, and wherein said end portion of said cone-shaped pipe 4 is not inserted in said end portion 31 of said conduit 3.

6. The cable-inserting apparatus according to claim 5, wherein an outer peripheral surface of said cone-shaped pipe 4 has a rubber layer.

7. The cable-inserting apparatus according to claim 1:
having a water tank 5 for separating water from the air flow in said air hose 2, wherein said water tank 5 has a pipe member 51 and a pipe member 52, wherein said pipe member 51 and 52 are extending downward from an upper portion of said water tank 5, wherein an upper portion of said pipe member 51 is connected to the first hose 2A of said air hose 2, and wherein an upper portion of said pipe member 52 is connected to the second hose 2B of said air hose 2.

8. The cable-inserting apparatus according to claim 7, wherein said water tank has a water pump 100 for draining water from said water tank 5.

9. The cable-inserting apparatus according to claim 8, wherein said water pump 100 has a check valve.

10. The cable-inserting apparatus according to claim 1, wherein said air hose 2 has plural small air hoses 22A and 22B connected separately to plural small suction apparatuses 1A and 1B, and wherein said plural small air hoses 22A and 22B are connected in parallel to an end opening of said conduit 3.

11. The cable-inserting apparatus according to claim 1:
having a cone-shaped pipe 4 with the shape of the conic barrel, wherein said cone-shaped pipe 4 has a top portion with smaller diameter and a end portion with larger diameter than an inner diameter of said conduit 3, wherein said top portion of said cone-shaped pipe 4 is inserted in an end portion 31 of said conduit 3, wherein said end portion of said cone-shaped pipe 4 is not inserted in said end portion 31 of said conduit 3, and wherein said plural small air hoses 22A and 22B are inserted in parallel to said cone-shaped pipe 4.

12. The cable-inserting apparatus according to claim 11:
having joint pipes 20A and 20B inserted in said cone-shaped pipe 4, wherein said plural small air hoses 22A and 22B are connected to said joint pipes 20A and 20B separately and absorb air in said conduit 3 through said joint pipes 20A and 20B.

13. The cable-inserting apparatus according to claim 1:
having an inserting member 400 consisting of an elastic cylinder member 41 and an joint pipe member 42, wherein a head portion of said elastic cylinder member 41 is inserted in an end portion 31 of said conduit 3, wherein a tail portion of said elastic cylinder member 41 having larger diameter than said conduit 3 is disposed out of said conduit 3, wherein said joint pipe member 42 penetrates through said elastic cylinder member 41, and wherein said suction apparatus 1 absorbs air in said conduit 3 through said air hose 2 connected to an end portion of said joint pipe member 42.

14. The cable-inserting apparatus according to claim 13, wherein said suction apparatus 2 consists of plural small suction apparatuses 1A and 1B, wherein said air hose 2 consists of plural small air hose 22A and 22B, wherein a plurality of said joint pipe members 42 penetrating in parallel through said elastic cylinder member 41, and wherein said small suction apparatuses 1A and 1B absorbs air in said conduit 3 in parallel through said plural small air hose 22A and 22B connecting in parallel to said plurality of said joint pipe members 42.
